(19) United States
(12) Patent Application Publication
(10) Pub. No.: US 2025/0291061 A1
(43) Pub. Date: Sep. 18, 2025

(54) Method for Determining Protection Levels of a GNSS-Based Locating System for a Vehicle Using a Bayes' Framework

(71) Applicant: Robert Bosch GmbH, Stuttgart (DE)

(72) Inventors: Alexander Metzger, Rottenacker (DE); Elena Sgarz, Leonberg (DE); Mohammad Tourian, Stuttgart (DE)

(21) Appl. No.: 19/080,815

(22) Filed: Mar. 15, 2025

(30) Foreign Application Priority Data
Mar. 18, 2024 (DE) 10 2024 202 522.4

(51) Int. Cl. G01S 19/20

(52) U.S. Cl. CPC G01S 19/20

(57) ABSTRACT

A method for determining protection levels of a GNSS-based locating system for a vehicle is disclosed. The method includes providing at least one first probability distribution for a safety-relevant error as a function of GNSS quality indicators with the aid of training data such that the GNSS quality indicators were predetermined as random variables of the at least one first probability distribution based on the training data, the values of which can be determined epoch by epoch while the vehicle is traveling, wherein the at least one first probability distribution was stored in advance and can be used to determine protection levels while the vehicle is traveling. The method further includes determining protection levels while the vehicle is traveling with the following sub-steps (i) determining the values of the respective GNSS quality indicators for the current epoch, (ii) determining a posteriori distribution from the at least one first probability distribution with the determined values of the respective GNSS quality indicators based on Bayes' theorem, (iii) determining a protection level from the posteriori distribution for the current epoch, and (iv) repeating the sub-steps (i) to (iii) for determining a protection level for the next epoch.

This application claims priority under 35 U.S.C. § 119 to application no. DE 10 2024 202 522.4, filed on Mar. 18, 2024 in Germany, the disclosure of which is incorporated herein by reference in its entirety.

### BACKGROUND

The present disclosure relates to a method for determining protection levels of a GNSS-based locating system for a vehicle using a Bayes' framework. Also disclosed are a control unit, a computer program, a machine-readable storage medium and a locating system. The disclosure can particularly be used in GNSS-based locating systems for automated or autonomous driving.

It is known that the position determination and navigation on Earth and in the air can be carried with a Global Navigation satellite System (GNSS) by receiving navigation satellite signals. With the aid of the multi-frequency and multi-constellation reception, positions on the earth can be precisely determined to the centimeter. The quality of these positions results from the fact that the requirements placed on them, in particular accuracy, continuity, availability and integrity, are fulfilled.

It can be found that integrity and positioning accuracy play a very important role in safety critical autonomous driving, as integrity ensures the reliability of positioning accuracy, and poor integrity monitoring can lead to catastrophic consequences in safety critical environment scenarios.

Originally, the term “integrity” for position determination and navigation in the air has been introduced and may be described with respect to position errors with the following parameters:
Alert Limit (AL) describes a position error tolerance that cannot be exceeded. Otherwise, an alert will be triggered.
Time to Alert (TTA) describes the maximum allowable time interval that may elapse from exceeding the AL until the alert is triggered.
Integrity Risk (IR) describes the probability that the position error exceeds the AL.
Position Error (PE) describes the deviation between the determined and the actual positions.
Protection Level (PL) describes the position error in which the algorithm guarantees that it is not exceeded undetected.
False Alarm (FA) describes the event that an alert is triggered without exceeding the AL.
Misleading Information (MI) describes the event where the PL is less than the position error, and the PL and the position error are less than the AL.
Hazardously Misleading Information (HMI) describes the event where the PL is less than the position error and the AL, and the position error exceeds the AL.

The Protection-Level (PL) parameter is the core of integrity monitoring which, along with the position, can be output by the locating system and ensures that the entire system is safe if the position error is below the prescribed AL.

The known methods for determining protection levels were typically developed within the framework of the ABSA, GBAS or SBAS concept, namely for position determination and navigation in the air (e.g. Greer et al., 2007, Gratton et al., 2010, Zhu et al., 2018), whose standardized integrity algorithms were typically defined considering the reception conditions of flying aircraft and are therefore not suitable, to be used for the position determination and navigation on Earth for autonomous driving in view of many critical environmental conditions (e.g., in urban surroundings) and reception conditions (e.g., multi-path reception). In addition, the methods developed as part of the ABSA, GBAS or SBAS concept generally refer to single frequency reception. In contrast, as mentioned above, autonomous driving requires multi-frequency and multi-constellation reception.

Although the known ARAIM concept (Blanch et al., 2007) was developed with a view of multi-frequency and multi-constellation reception for providing information about degraded GNSS satellites and is more robust than the ABSA, GBAS or SBAS concepts in terms of a lower ionospheric run time delay due to the multi-frequency reception and a higher measurement redundancy due to the multi-constellation reception, it seems difficult to implement this concept in the method for determining protection levels for position determination and navigation on Earth. In this context, the following challenges exist in particular:

The use of non-ionospheric (IF) measurements is known to increase the extent of errors that are not correlated between frequencies, such as thermal noise, multi-path effects, or certain distortions. In a typical road environment, this can lead to large position uncertainties.

In addition, aviation GNSS receivers typically perform phase smoothing of the pseudo-range over 100 seconds to reduce noise and multi-path effects. This approach cannot be used in car driving, as carrier phase tracking is unlikely to be reliably maintained for very long due to environmental conditions.

In addition, most planned applications in the automotive industry are expected to have a more stringent AL and TTA than in aviation (typically AL in the range of 0.5 to 10 meters and TTA in the range of 1 second) without necessarily requiring a less stringent integrity risk (IR). This means that the typical magnitude of the ARAIM concept can lead to an oversized PL.

It is therefore desirable to create a method for determining protection levels in the context of position determination and navigation on Earth, which can be used not only for multi-frequency and multi-constellation reception, but also for determining a robust protection level under critical environmental conditions. This is particularly significant for autonomous driving, because, in addition to positional accuracy, autonomous driving places particularly high demands on the safety and integrity and/or correctness of the location information.

### SUMMARY

Contributing hereto is a method for determining protection levels of a GNSS-based locating system for a vehicle, with the steps of:
a) providing at least one first probability distribution for a safety-relevant error as a function of GNSS quality indicators with the aid of training data, such that the GNSS quality indicators were predetermined as random variables of the at least one first probability distribution based on the training data, the values of which can be determined epoch by epoch while the vehicle is traveling, wherein the at least one first probability distribution was stored in advance and can be used to determine protection levels while the vehicle is traveling, and
b) determining protection levels while the vehicle is traveling with the following sub-steps:
   i) determining the values of the respective GNSS quality indicators for the current epoch,
   ii) determining a posteriori distribution from the at least one first probability distribution with the determined values of the respective GNSS quality indicators based on Bayes' theorem,
   iii) determining a protection level from the posteriori distribution for the current epoch, and
   iv) repeating the sub-steps i) to iii) for determining a protection level for the next epoch.

The method described is particularly suitable for autonomous driving. In this context, autonomous driving in particular refers to the movement of vehicles that behave largely autonomously by way of a locating system and based on Global Navigation Satellite Systems (GNSS). The vehicles may be motor vehicles, for example a passenger car, a truck or another commercial vehicle, a robot or similar. It is particularly advantageous if a self-driving motor vehicle with a locating system is equipped with a locating system for carrying out the described method. The locating system may be a GNSS-based or a GNSS and INS-based locating system.

The described method comprises primarily an offline processing part according to step a) and an online processing part according to step b).

In the offline processing part, according to step a), at least one first probability distribution is provided in advance for a safety-relevant error as a function of GNSS quality indicators with the aid of training data, such that the GNSS quality indicators were predetermined as random variables of the at least one first probability distribution based on the training data, the values of which can be determined epoch by epoch while the vehicle is traveling, wherein the at least one first probability distribution has been stored in advance and can be used to determine protection levels while the vehicle is traveling.

To distinguish it from the new probability distributions generated later in the online processing part, the probability distribution previously provided with training data in step a) is referred to here as the first probability distribution. Advantageously, the at least one first probability distribution in the form of a software product can be stored in memory and thus read from the memory in the online processing part, i.e., while the vehicle is traveling, and used to determine protection levels.

The safety-relevant error may be a measurement error of the GNSS-based locating system, such as position error, speed error, or orientation error, that needs to be monitored. A protection level thus defines an error limit at which the GNSS-based locating system ensures that an above-mentioned safety-relevant error does not exceed this error limit without being detected. If this error limit is exceeded, at least one alert must be triggered. The determination of a protection level is thus essentially the determination of the above-mentioned error limit.

The at least one first probability distribution of a safety-relevant error may be provided in the form of multivariate, bivariate, and/or univariate conditional distributions. In so doing, the GNSS quality indicators may be used as random variables for providing the at least one first probability distribution.

GNSS quality indicators are key signals or key variables of a GNSS system that can be measured and/or calculated, e.g., using the GNSS-based locating system during vehicle movement. GNSS quality indicators characterize the quality of the position estimate for positioning algorithms. A typical GNSS quality indicator is e.g. Dilusion [sic: Dilution] of Precision (DOP). DOP is a measure of quality for the available GNSS signals under visual conditions and describes how well suited the GNSS satellites are positioned relative to each other for position determination. A further typical GNSS quality indicator is, for example, the number of GNSS signals available in the field of view. As at least four GNSS signals are typically required for positioning, at least five GNSS signals for integrity monitoring, and at least six GNSS signals for identifying defective GNSS satellites, the number of available GNSS signals is also great importance for positioning quality.

The type and number of GNSS quality indicators may be predetermined or predefined in the offline processing part, e.g. IQ1 for Dilution of Precision (DOP), IQ2 for the number of available GNSS signals, etc. The specification of GNSS quality is possible as each GNSS system has a variety of GNSS satellites (e.g., GPS may have 24 GPS satellites) which are distributed in the sky and move according to a certain movement pattern. This means that at a certain location in a certain time interval, only certain GNSS signals can be received from certain GNSS satellites. For this purpose, the movement patterns (e.g. in the form of the almanac and/or ephemeris) are publicly available and can be downloaded (e.g. from the International GNSS Service (ISG)).

With the additional environment-relevant training data, which may be collected by test runs, for example, further GNSS quality indicators such as the carrier-to-noise ratio can also be predefined. It is advantageous to provide sufficient training data such that the training data matches the real data while the vehicle is traveling, i.e. the training data should have the same statistical population as the real data. Furthermore, it must be ensured that the training data does not have any reference issues. Based on this training data, the most relevant GNSS quality indicators are to be determined.

The values of the GNSS quality indicators may be measured and/or calculated online in the online processing part according to step b), i.e., while the vehicle is traveling, in a known manner online, e.g., using the GNSS-based locating system. Thus, it is possible to use the measured and/or calculated values of the respective GNSS quality indicators to convert the at least one first probability distribution into conditional error distributions if the respective GNSS quality indicators are used as random variables of the at least one first probability distribution in step a). With the newly formed conditional error distributions and based on Bayes' theorem, the protection levels can be determined repeatedly epoch for epoch according to step b) and with the sub-steps i) to iv).

According to sub-step i), the values of the respective GNSS quality indicators for the current epoch are determined. They can be measured and/or calculated based on the current navigation data and the current sensor data and with the aid of a filter in the GNSS locating system.

According to sub-step ii), a posteriori distribution is determined from the at least one first probability distribution with the determined values of the respective GNSS quality indicators based on Bayes' theorem.

In general, Bayes' theorem may be described by the formula:

$$P ( x \vert yz ) ∝ \frac{P ( x \vert y ) P ( x \vert z )}{P ( x )} ,$$

A posteriori distribution may be derived according to the Bayes' theorem by multiplying a likelihood function by a priori distribution. The likelihood function can be derived from one or more conditional error distributions that can be derived from the at least one first probability distribution when the values of the corresponding GNSS quality indicators are determined and set. The priori distribution can be assumed to be obvious based on general prior knowledge or seemingly reasonable basic assumptions about symmetric properties. Here, the priori distribution can be defined based on the training data and using a parametric distribution.

According to sub-step iii), a protection level is determined from the posteriori distribution for the current epoch. The protection level can be calculated according to the following formula:

$${\int }_{PL 1}^{PL 2} f ( PE ) dPE \geq 1 - IR$$

PL1 and PL2 are the protection levels to be determined, f(PE) is the posteriori distribution determined in sub-step ii) and IR is the integrity risk. With the defined integrity risk, i.e. the Target Integrity Risk (TIR), the upper and lower limits of the posteriori distribution f(PE) can be determined according to the formula above, wherein the upper limit corresponds to PL2 and the lower limit to PL1, and a safety-relevant error must not exceed the upper and lower limits undetected. If the upper and lower limits are exceeded, at least one alert must be triggered.

According to step iv), the sub-steps i) to iii) are repeated for determining protection levels epoch by epoch.

An epoch can be understood herein as a time step in which the position estimated by the GNSS location system by receiving GNSS signals is updated once. This may mean that the sub-steps i) to iii) are performed once with each position update so that the currently determined protection level can be output along with the updated position. This may also mean that all parameters relevant to the position determination are updated once in an epoch. These relevant parameters include GNSS quality indicators such as Dilusion [sic: Dilution] of Precision (DOP) or the number of available GNSS signals in the field of view.

With the method described herein, the protection levels of a GNSS-based location system for a vehicle are not determined as in known methods with a single GNSS signal, but according to the disclosure with a plurality of GNSS quality indicators. In addition, the method described herein is generally only based on the assumption for the state error distributions with the training data, which have the same statistical population as the real data while the vehicle is traveling and can be obtained, for example, by test drives. Thus, in the described method, it is no longer necessary to make a theoretical assumption for the observational error distributions, as shown in the prior art. This means that the protection levels are determined with the described method not at the observation level but at the state level. This has the advantage that more GNSS signals can be used via the GNSS quality indicators in the analysis at the state level. This further has the advantage that the state errors can be derived more simply and with less uncertainties as compared to the observation errors. This also has the advantage that the computational effort can be reduced, as complex model parameterization for the analysis of observational errors is omitted.

It is preferred when in step a) the at least one first probability distribution was provided in the form of a multivariate distribution with n+1 random variables, wherein n is the number of GNSS quality indicators and +1 is an error to be limited. The multivariate distribution is determined here with f(Error, Oi1, Oi2, . . . Oin). If the values of the respective GNSS quality indicators for the current epoch are determined in sub-step i), a conditional error distribution f(Error|(Qi1 Qi2 . . . Qin)) can be derived. A likelihood function can be derived from this conditional error distribution, which can then be used to determine the posteriori distribution with the aid of Bayes' theorem.

It is preferred when in step a) the at least one first probability distribution was provided in the form of n bivariate distributions, wherein n is the number of GNSS quality indicators. The bivariate distributions are referred to herein as f1(Error, Qi1), f2(Error, Qi2), . . . , fn (Error, Qin). If the values of the respective GNSS quality indicators for the current epoch are determined in sub-step i), the posteriori distribution f(Error|Qi1 Qi2 . . . Qi2 Qin) can be derived according to Bayes' theorem by multiplying n likelihood functions and division by a prior probability, wherein the n likelihood functions can be derived from the n bivariate distributions with the known values of the respective GNS quality indicators.

It is preferred when in step a) the at least one first probability distribution was provided in the form of n*q univariate conditional distributions, wherein n is the number of GNSS quality indicators and q is the number of bins.

The univariate conditional distributions are referred to herein as f1_q (Error|Qi1′q), f2_q (Error|Qi2′q), . . . , fn_q (Error|Qin′q), where n is the number of GNSS quality indicators and q is the number of bins used to discretize the respective GNSS quality indicators.

The univariate conditional distributions can be provided using binning. Binning generally refers to the division of the range of values of data into intervals of the same size, wherein the intervals can be determined according to certain criteria. Each interval corresponds to a bin. Data points that fall within a certain interval are associated with the corresponding bin. This categorization facilitates analysis and interpretation of the data.

Binning is used to discretize the continuous value range of a GNSS quality indicator into a predetermined number of bins, wherein the number of bins is denoted here as q. A univariate conditional distribution is thus derived for each bin. In other words, this means that for each GNSS quality indicator q, univariate conditional distributions f1_q(Error|Qi1εq) are formed so that for n GNSS quality indicators n*q univariate conditional distributions fn_q (Error|Qin′q) are formed. The posteriori distribution can be derived from Bayes' theorem by multiplying likelihood functions and division by a prior probability, wherein the likelihood functions can be derived from the univariate conditional distributions f1_q(Error|Qi1εq), f2_q(Error|Qi2εq) . . . , fn_q(Error|Qin∈q).

It is preferred when in step a), a protection level for each univariate conditional distribution with a given integrity risk was calculated in advance and stored. The values of the protection levels are then forwarded to the online processing part, where they are combined into a final value of the protection level.

It is preferred if the training data was acquired by test measurements and/or simulations. The training data may be obtained from measurements in the real field and/or from simulated test data. Simulated test data may e.g. be generated by a GNSS signal generator capable of taking into account various environmental conditions such as multi-path propagation.

It is preferred when a prior distribution based on the training data and using a parametric distribution has been predefined.

It is preferred when the safety-relevant error is a position error, a speed error, or an orientation error.

It is preferable if a control device for the GNSS receiver is configured to perform the described method.

It is additionally preferred if a computer program is used to carry out a method described here. In other words, this relates in particular to a computer program (product) comprising commands which, when the program is executed by a computer, prompt said computer to perform a method described herein.

It is also preferable if a machine-readable storage medium is used, on which the computer program proposed herein is stored. The machine-readable storage medium is typically a computer-readable data carrier.

It is preferred in particular if the locating system for a vehicle is configured to perform a method described here.

### BRIEF DESCRIPTION OF THE DRAWINGS

The solution presented here and its technical environment are explained in more detail below, using the figures. It should be noted that the disclosure is not intended to be limited by the exemplary embodiments shown. In particular, unless explicitly stated otherwise, it is also possible to extract partial aspects of the facts explained in the figures and to combine them with other components and/or insights from other figures and/or the present description. It shows schematically and by way of example:

FIG. 1: a functional graph for Bayes' theorem,

FIG. 2: Functional graphs for the at least one first probability distribution in the form of bivariate distributions,

FIG. 3: Functional graphs for at least one first probability distribution in the form of univariate conditional distributions, and

FIG. 4: a block diagram of a described method.

### DETAILED DESCRIPTION

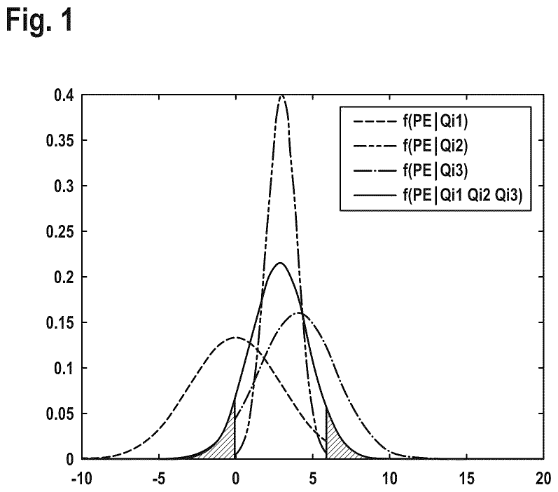

FIG. 1 shows a schematic and exemplary function graph for Bayes' theorem, in which the relationship between a conditional failure distribution f(PE|Qi1) as a function of a particular GNSS quality indicator Qi1, a conditional error distribution f(PE|Qi2) as a function of a particular GNSS quality indicator Qi2, a conditional failure distribution f(PE|Qi3) as a function of a particular GNSS quality indicator Qi3 and a conditional error distribution f(PE|Qi1Qi2Qi3) as a function of the quality indicators Qi1, Qi2 Qi3 are represented. The above conditional error distributions and their relationship may also be represented by the following formula:

$$P ( x \vert yz ) ∝ \frac{P ( x \vert y ) P ( x \vert z )}{P ( x )} ,$$

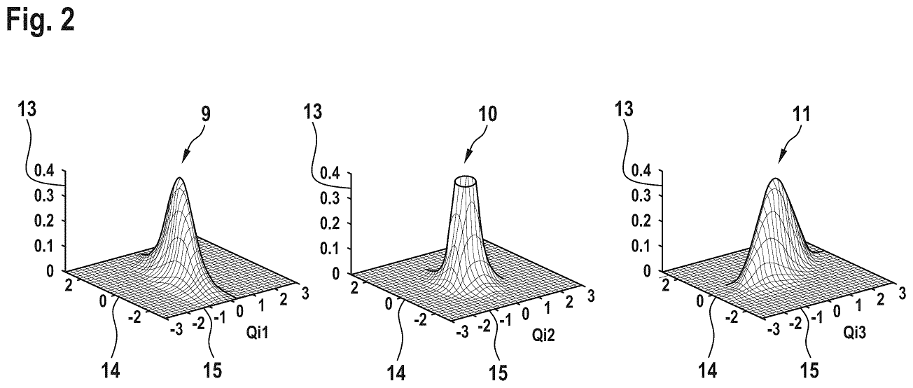

FIG. 2 schematically and exemplary shows three functional graphs for the at least one first probability distribution in the form of three bivariate distributions.

In FIG. 2, it can be seen that three GNSS quality indicators Qi1, Qi2, Qi3 are provided in the offline processing part so that a bivariate distribution can be provided for each of the GNSS quality indicators, namely f(PEx, Qi1) 9, f(PEx, Qi2) 10 and f(PEx,Qi3) 11. The number of GNSS quality indicators in FIG. 2 is just one example. When using the described method, fewer or more than three may be predetermined.

It can also be seen in FIG. 2 that each of the bivariate distributions 9, 10, 11 has two random variables, namely, an error to be limited and a predetermined GNSS quality indicator. The error probabilities 13 are thus distributed two-dimensionally across the error value range 14 and the GNSS quality indicator value range 15.

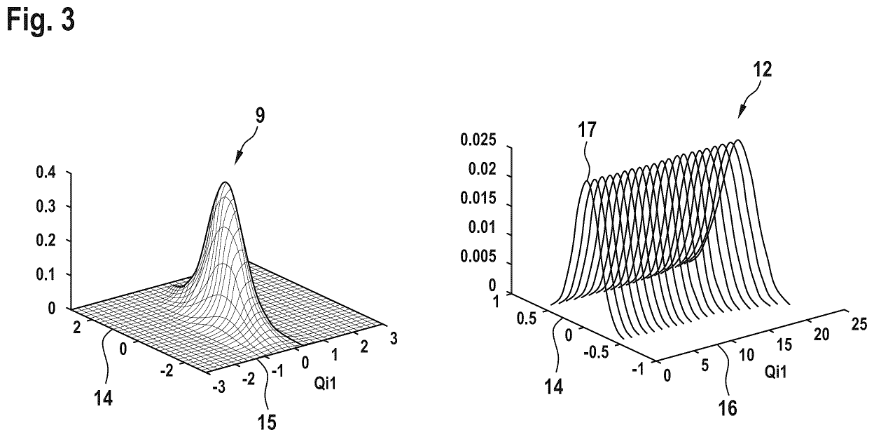

FIG. 3 schematically and exemplary shows functional graphs for at least one first probability distribution in the form of univariate conditional distributions.

It can be seen in FIG. 3 that starting from a bivariate distribution f(PEx, Qi1) 9, a plurality of univariate conditional distributions fᵢ(PEx|Qi1) 12 are formed with the aid of binning, where q is the number of bins 16. The continuous GNSS quality indicator value range 15 is discretized in q bins so that a univariate conditional distribution 17 is derived for each bin and a total of q univariate conditional distributions are formed for the GNSS quality indicator Qi1. For example, for the GNSS quality indicator Qi1 in FIG. 3, twenty-one univariate conditional distributions (i.e. q=21) are shown.

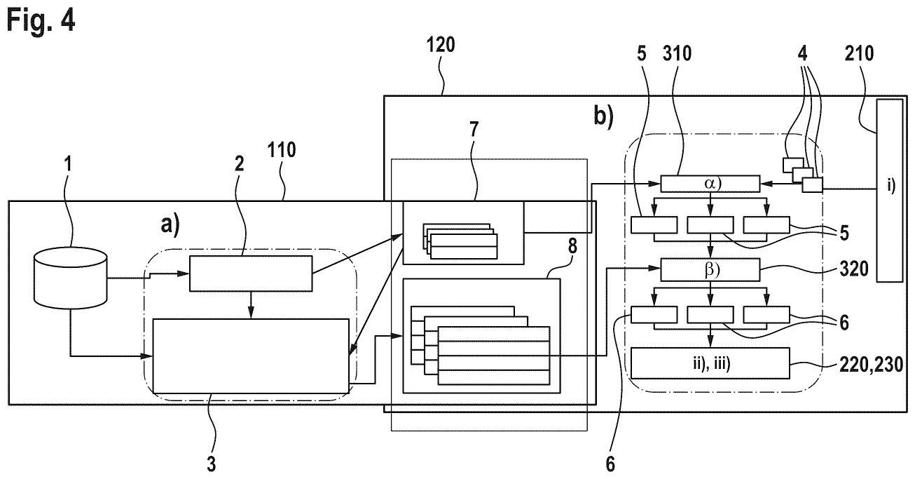

FIG. 4 schematically and exemplary shows the data flow of a described method. The illustrated order of the method steps a) and b) with the blocks 110 and 120, and the shown order of the sub-steps i), ii) and iii) with the blocks 210, 220 and 230, are exemplary only.

In block 110, at least one first probability distribution 3 for a safety-relevant error is provided as a function of GNSS quality indicators 2 with the aid of training data 3, such that the GNSS quality indicators 2 were predetermined as random variables of the at least one first probability distribution 3 based on the training data 2, the values of which can be determined epoch by epoch while the vehicle is traveling, wherein the at least one first probability distribution 3 was stored and can be used to determine protection levels while the vehicle is traveling.

The at least one first probability distribution 3 may be provided in any one of the following embodiments:
1) a multivariate distribution f(Error, Oi1, Oi2, . . . Oin), wherein n is the number of GNSS quality indicators and 1 is an error to be limited,
2) n bivariate distributions f1(Error, Qi1), f2(Error, Qi2), . . . , fn(Error, Qin), wherein n is the number of GNSS quality indicators, or
3) n*q univariate conditional distributions f1_q (Error|Qi1′q), f2_q (Error|Qi2′q), . . . , fn_q (Error|Qin′q), wherein n is the number of GNSS quality indicators and q is the number of bins.

In block 120, protection levels are determined while the vehicle is traveling. In so doing, for an epoch t, the sub-steps i) to iii) can be performed to determine a protection level for that epoch. The sub-steps i) to iii) may also be repeated to determine a protection level for the next epoch t+1.

In block 210, the sub-step i) is performed, namely, determining the GNSS quality indicator values 4 for the epoch t, which can be measured and/or calculated with the aid of a filter in the GNSS-based locating system.

If the at least one first probability distribution is performed in embodiments 1) and 2), then the determined GNSS quality indicator values 4 may be used directly to derive conditional error distributions 6 and likelihood functions, respectively.

If the at least one first probability distribution is performed in embodiment 3), the GNSS quality indicator values 4 are discretized into a plurality of Qin_BinIDs 5 according to the addition step a) in block 310 using bin edges, for example in Qi1_BinID, Qi2_BinID and Qi3_BinID. After discretizing the GNSS quality indicator values 4, a corresponding likelihood function can be derived for each discrete GNSS quality indicator value 4, which is then used to derive the posterior distribution and thus calculate the protection level in blocks 220, 230 according to sub-steps ii) and iii).

Preferably, the bin edges may be provided in advance and stored in first lookup tables 7 when the at least one first probability distribution is performed in embodiment 3). Thus, the first lookup tables 7 with bin edges may be available for both providing the at least one first probability distribution 3 in the form of univariate conditional distributions and for discretizing the GNSS quality indicator values 4 measured online.

Further preferably, the n*q univariate conditional distributions may be stored in second lookup tables 8 when the at least one first probability distribution is performed in embodiment 3). Thus, in accordance with the additional step B), in block 320, conditional error distributions 6, such as fi(PEx|Qi1), fi(PEx|Qi2), fi(PEx|Qi3), may be determined from the second lookup tables 8.

What is claimed is:

1. A method for determining protection levels of a GNSS-based locating system for a vehicle, comprising:
a) providing at least one first probability distribution for a safety-relevant error as a function of GNSS quality indicators with the aid of training data, such that the GNSS quality indicators were predetermined as random variables of the at least one first probability distribution based on the training data, the values of which are determined epoch by epoch while the vehicle is traveling, wherein the at least one first probability distribution has been stored in advance and is used to determine protection levels while the vehicle is traveling, and
b) determining protection levels while the vehicle is traveling with the following sub-steps:
(i) determining the values of the respective GNSS quality indicators for the current epoch,
(ii) determining a posteriori distribution from the at least one first probability distribution with the determined values of the respective GNSS quality indicators based on Bayes' theorem,
(iii) determining a protection level from the posteriori distribution for the current epoch, and
(iv) repeating the sub-steps (i) to (iii) for determining a protection level for the next epoch.

2. The method according to claim 1, wherein in step a) the at least one first probability distribution was provided in the form of a multivariate distribution with n+1 random variables, wherein n is the number of GNSS quality indicators and +1 is an error to be limited.

3. The method according to claim 1, wherein in step a) the at least one first probability distribution was provided in the form of n bivariate distributions, wherein n is the number of GNSS quality indicators.

4. The method according to claim 1, wherein in step a) the at least one first probability distribution was provided in the form of n*q univariate conditional distributions, wherein n is the number of GNSS quality indicators and q is the number of bins.

5. The method according to claim 4, wherein in step a), a protection level for each univariate conditional distribution with a given integrity risk was calculated in advance and stored.

6. The method according to claim 1, wherein the training data was acquired by test measurements and/or simulations.

7. The method according to claim 1, wherein a prior distribution based on the training data and using a parametric distribution has been predefined.

8. The method according to claim 1, wherein the safety-relevant error is a position error, a speed error, or an orientation error.

9. A control unit, which is configured to carry out a method according to claim 1.

10. A computer program for carrying out a method according to claim 1.

11. A machine-readable storage medium on which the computer program according to claim 10 is stored.

12. A locating system for a vehicle which is configured to perform a method according to claim 1.
